(19) United States
(12) Patent Application Publication
(10) Pub. No.: US 2013/0212527 A1
(43) Pub. Date: Aug. 15, 2013

(54) SYSTEM AND METHOD FOR AUTOMATICALLY BINDING SOFTWARE APPLICATIONS TO DEVICES

(71) Applicant: John W. Sublett, Richmond, VA (US)

(72) Inventor: John W. Sublett, Richmond, VA (US)

(73) Assignee: Honeywell International Inc., Morristown, NJ (US)

(21) Appl. No.: 13/369,496

(22) Filed: Feb. 9, 2012

(51) Int. Cl. G06F 3/048

(52) U.S. Cl. 715/810

(57) ABSTRACT

A system stores semantic information relating to several devices. The semantic information relates to a description of data that are associated with the devices. The system stores a database of software applications that can be used in connection with the devices. The system displays to an output device one or more software applications that can be used in connection with a particular device, and receives into the system a selection of the one or more software applications that are to be used in connection with the particular device. The system transmits data to and receives data from the particular device as a function of requirements of the selected one or more software applications and semantic information relating to the particular device.

### TECHNICAL FIELD

The present disclosure relates to a system and method for automatically binding software applications to devices.

### BACKGROUND

Machine to machine (M2M) systems integrate devices and allow device data to be used in software applications. Most software applications are designed to work with specific types of devices, and binding applications to the correct devices is a manual process requiring configuration by a user. This workflow creates a tight coupling between the software application and the device, and puts a burden on system integrators to select the devices for a specific software application. This results in higher costs of deploying M2M software applications and a fragile system requiring additional configuration for every device that is added to or removed from the system.

### BRIEF DESCRIPTION OF THE DRAWINGS

FIG. 1 is a diagram of the features of a system and method that automatically binds software applications to devices.

FIG. 2 is a block diagram of a computer system upon which embodiments of the present disclosure can execute.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, electrical, and optical changes may be made without departing from the scope of the present invention. The following description of example embodiments is, therefore, not to be taken in a limited sense, and the scope of the present invention is defined by the appended claims.

One or more embodiments apply several concepts that together change the typical workflow for deploying machine to machine (M2M) systems and software applications. These embodiments result in reduced commissioning time and better software application reuse across systems. An embodiment also provides system integrators with better awareness of existing applications for the devices in a system, and an avenue for software application developers to make their software applications available to the marketplace.

The features and concepts of the one or more embodiments include an abstract device model that captures the semantic information about each device and includes device contracts describing the data associated with each device. Another feature is a software application registry that allows software applications to specify the device contracts to which they can be applied. Another feature is a notification to interested users of a system when an application is available for a device or devices in the system.

The general concept of the embodiments is to make users of the system aware of the software applications that are available for integrated devices in an M2M system as those devices are added to the system, and to create the binding between the software applications and devices in a few simple steps.

In an abbreviated manner, the system and method function as follows. A software framework is created that allows devices to be modeled with semantic information and well known data values for each device type. In the software framework, the device information is made available to software applications both inside and outside of the software framework. A registration mechanism is provided that allows software applications to be associated with the device types that they support. Lastly, a binding mechanism is provided that causes data to flow between the associated devices and the software applications.

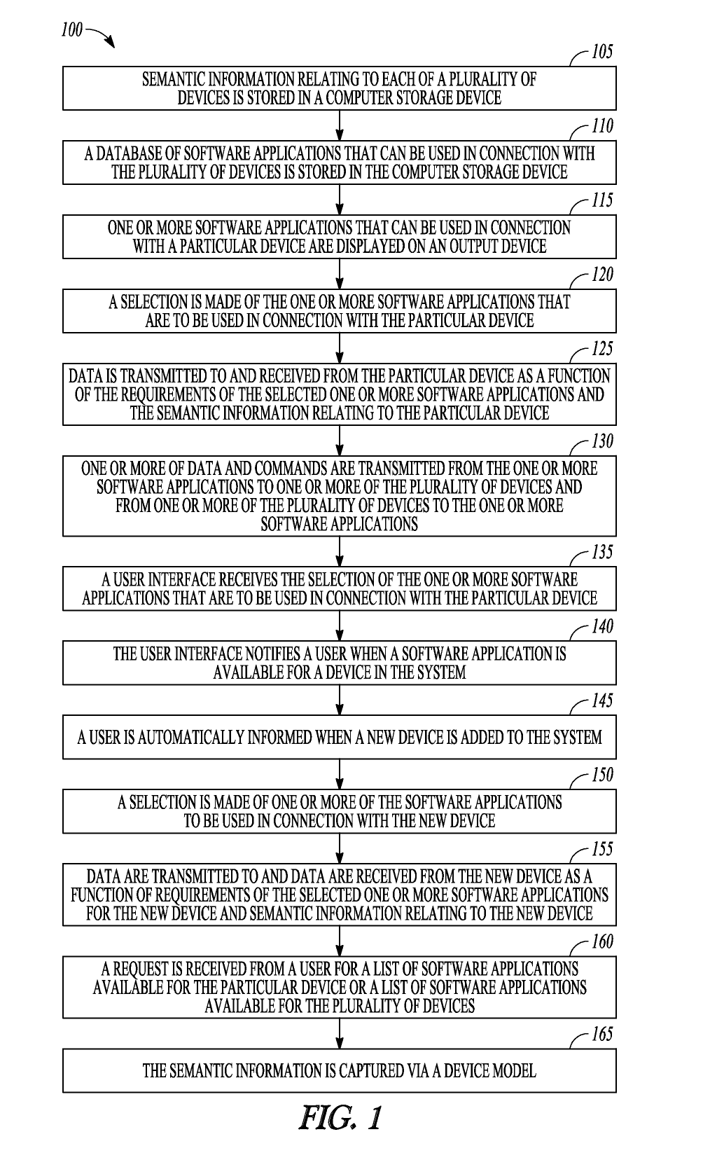

FIG. 1 is a more detailed diagram of features of a system and method for automatically binding software applications to devices. FIG. 1 includes a number of blocks 105-165. Though arranged serially in a flowchart-like format in the example of FIG. 1, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring now to FIG. 1, at 105, semantic information relating to each of a plurality of devices is stored in a computer storage device. The semantic information includes a description of the data that are associated with the plurality of devices. The devices can include such things as air condition units, lighting systems, audio systems, heating systems, and security systems. For example, if the device is an air conditioning unit, the semantic information may include turn on and turn off times of the system, a set point for when the system automatically turns on, power requirements (volts/amps) for the unit, and the proper format for all of this information. At 110, a database of software applications that can be used in connection with the plurality of devices is stored in the computer storage device. At 115, one or more software applications that can be used in connection with a particular device are displayed on an output device. At 120, a selection is made of the one or more software applications that are to be used in connection with the particular device. At 125, data is transmitted to and received from the particular device as a function of the requirements of the selected one or more software applications and the semantic information relating to the particular device.

At 130, one or more of data and commands are transmitted from the one or more software applications to one or more of the plurality of devices and from one or more of the plurality of devices to the one or more software applications. At 135, a user interface receives the selection of the one or more software applications that are to be used in connection with the particular device. At 140, the user interface notifies a user when a software application is available for a device in the system. At 145, a user is automatically informed when a new device is added to the system. At 150, a selection is made of one or more of the software applications to be used in connection with the new device. At 155, data are transmitted to and data are received from the new device as a function of requirements of the selected one or more software applications for the new device and semantic information relating to the new device. At 160, a request is received from a user for a list of software applications available for the particular device or a list of software applications available for the plurality of devices. At 165, the semantic information is captured via a device model.

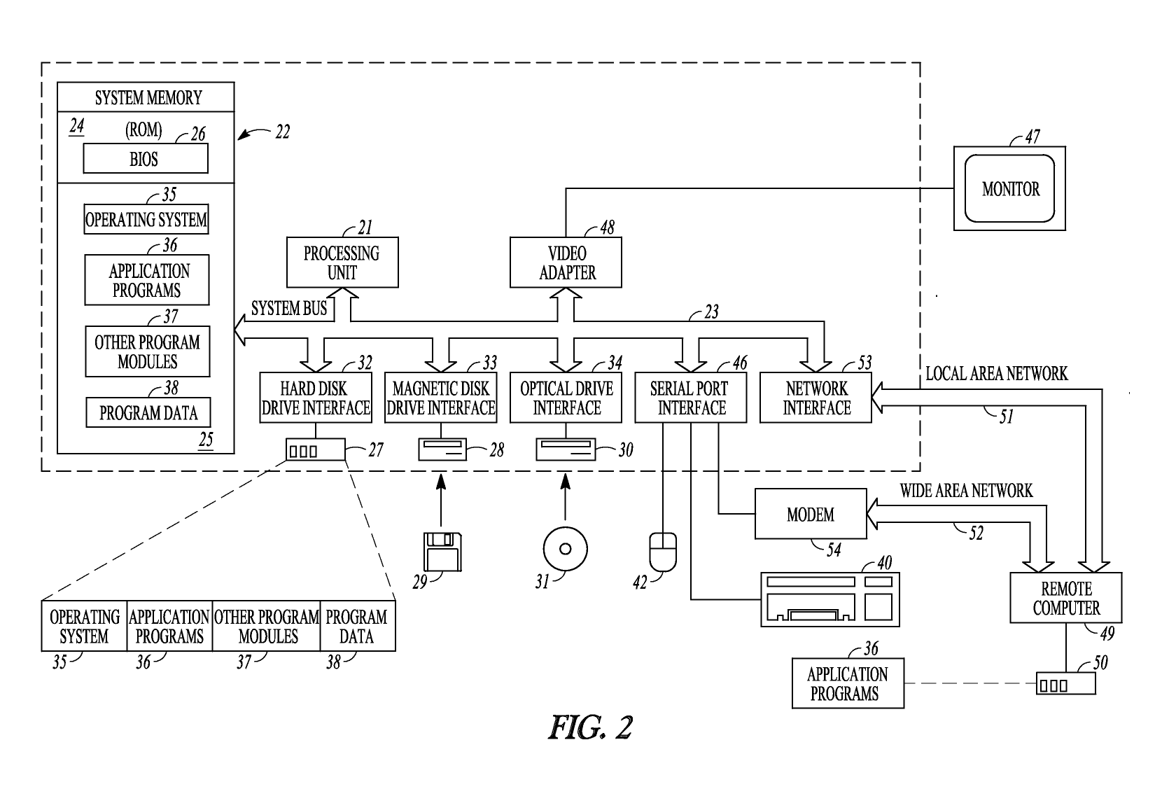

FIG. 2 is an overview diagram of hardware and an operating environment in conjunction with which embodiments of the invention may be practiced. The description of FIG. 2 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 2, a hardware and operating environment is provided that is applicable to any of the servers and/or remote clients shown in the other Figures.

As shown in FIG. 2, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 47 can display a graphical user interface for the user. In addition to the monitor 47, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 2 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

### EXAMPLE EMBODIMENTS

Several embodiments and sub-embodiments have been disclosed above, and it is envisioned that any embodiment can be combined with any other embodiment or sub-embodiment. Specific examples of such combinations are illustrated in the examples below.

Example No. 1 is a system including one or more of a computer processor and a computer storage device in a machine to machine system. The system is configured to store semantic information relating to each of a plurality of devices. The semantic information includes a description of data that are associated with the plurality of devices. The system is configured to store a database of software applications that can be used in connection with the plurality of devices. The system is configured to display to an output device one or more software applications that can be used in connection with a particular device, and to receive into the computer processor a selection of the one or more software applications that are to be used in connection with the particular device. The system is configured to transmit data to and receive data from the particular device as a function of requirements of the selected one or more software applications and semantic information relating to the particular device.

Example No. 2 includes the features of Example No. 1 and optionally includes a system that transmits one or more of data and commands from the one or more software applications to one or more of the plurality of devices and from one or more of the plurality of devices to the one or more software applications.

Example No. 3 includes the features of Example Nos. 1-2 and optionally includes a system including a user interface configured to receive the selection of the one or more software applications that are to be used in connection with the particular device.

Example No. 4 includes the features of Example Nos. 1-3 and optionally includes a system wherein the user interface is configured to notify a user when an application is available for a device in the system.

Example No. 5 includes the features of Example Nos. 1-4 and optionally includes a system wherein the computer processor is configured to automatically inform a user when a new device is added to the system, and to receive a selection of one or more of the software applications to be used in connection with the new device.

Example No. 6 includes the features of Example Nos. 1-5 and optionally includes a system wherein the computer processor is configured to transmit data to and receive data from the new device as a function of requirements of the selected one or more software applications for the new device and semantic information relating to the new device.

Example No. 7 includes the features of Example Nos. 1-6 and optionally includes a system wherein the computer processor is configured to receive a request from a user for a list of software applications available for the particular device or a list of software applications available for the plurality of devices.

Example No. 8 includes the features of Example Nos. 1-7 and optionally includes a system wherein the semantic information is captured via a device model.

Example No. 9 is a computer readable storage device including instructions that when executed by a processor execute a process comprising storing semantic information relating to each of a plurality of devices, the semantic information comprising a description of data that are associated with the plurality of devices; storing a database of software applications that can be used in connection with the plurality of devices; displaying to an output device one or more software applications that can be used in connection with a particular device; receiving a selection of the one or more software applications that are to be used in connection with the particular device; and transmitting data to and receiving data from the particular device as a function of requirements of the selected one or more software applications and semantic information relating to the particular device.

Example No. 10 includes the features of Example No. 9 and optionally includes instructions for transmitting one or more of data and commands from the one or more software applications to one or more of the plurality of devices and from one or more of the plurality of devices to the one or more software applications.

Example No. 11 includes the features of Example Nos. 9-10 and optionally includes instructions for a user interface to receive the selection of the one or more software applications that are to be used in connection with the particular device.

Example No. 12 includes the features of Example Nos. 9-11 and optionally includes instructions such that the user interface is configured to notify a user when an application is available for a device in the system.

Example No. 13 includes the features of Example Nos. 9-12 and optionally includes instructions for automatically informing a user when a new device is added to the system, and for receiving a selection of one or more of the software applications to be used in connection with the new device.

Example No. 14 includes the features of Example Nos. 9-13 and optionally includes instructions for transmitting data to and receiving data from the new device as a function of requirements of the selected one or more software applications for the new device and semantic information relating to the new device.

Example No. 15 includes the features of Example Nos. 9-14 and optionally includes instructions for receiving a request from a user for a list of software applications available for the particular device or a list of software applications available for the plurality of devices.

Example No. 16 is a process comprising storing in a computer storage device semantic information relating to each of a plurality of devices, the semantic information comprising a description of data that are associated with the plurality of devices; storing a database of software applications that can be used in connection with the plurality of devices; displaying to an output device one or more software applications that can be used in connection with a particular device; receiving into a computer processor a selection of the one or more software applications that are to be used in connection with the particular device; and transmitting data to and receiving data from the particular device as a function of requirements of the selected one or more software applications and semantic information relating to the particular device.

Example No. 17 includes the features of Example No. 16 and optionally includes automatically informing a user when a new device is added to the system, and receiving a selection of one or more of the software applications to be used in connection with the new device.

Example No. 18 includes the features of Example Nos. 16-17 and optionally includes transmitting data to and receiving data from the new device as a function of requirements of the selected one or more software applications for the new device and semantic information relating to the new device.

Example No. 19 includes the features of Example Nos. 16-18 and optionally includes receiving a request from a user for a list of software applications available for the particular device or a list of software applications available for the plurality of devices.

Example No. 20 includes the features of Example Nos. 16-19 and optionally includes capturing the semantic information via a device model.

It should be understood that there exist implementations of other variations and modifications of the invention and its various aspects, as may be readily apparent, for example, to those of ordinary skill in the art, and that the invention is not limited by specific embodiments described herein. Features and embodiments described above may be combined with each other in different combinations. It is therefore contemplated to cover any and all modifications, variations, combinations or equivalents that fall within the scope of the present invention.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
one or more of a computer processor and a computer storage device in a machine to machine system configured to:
store semantic information relating to each of a plurality of devices, the semantic information comprising a description of data that are associated with the plurality of devices;
store a database of software applications that can be used in connection with the plurality of devices;
display to an output device one or more software applications that can be used in connection with a particular device;
receive into the computer processor a selection of the one or more software applications that are to be used in connection with the particular device; and
transmit data to and receive data from the particular device as a function of requirements of the selected one or more software applications and semantic information relating to the particular device.

2. The system of claim 1, wherein the computer processor transmits one or more of data and commands from the one or more software applications to one or more of the plurality of devices and from one or more of the plurality of devices to the one or more software applications.

3. The system of claim 1, comprising a user interface configured to receive the selection of the one or more software applications that are to be used in connection with the particular device.

4. The system of claim 3, wherein the user interface is configured to notify a user when an application is available for a device in the system.

5. The system of claim 1, wherein the computer processor is configured to automatically inform a user when a new device is added to the system, and to receive a selection of one or more of the software applications to be used in connection with the new device.

6. The system of claim 5, wherein the computer processor is configured to transmit data to and receive data from the new device as a function of requirements of the selected one or more software applications for the new device and semantic information relating to the new device.

7. The system of claim 1, wherein the computer processor is configured to receive a request from a user for a list of software applications available for the particular device or a list of software applications available for the plurality of devices.

8. The system of claim 1, wherein the semantic information is captured via a device model.

9. A computer readable storage device comprising instructions that when executed by a processor execute a process comprising:
storing semantic information relating to each of a plurality of devices, the semantic information comprising a description of data that are associated with the plurality of devices;
storing a database of software applications that can be used in connection with the plurality of devices;
displaying to an output device one or more software applications that can be used in connection with a particular device;
receiving a selection of the one or more software applications that are to be used in connection with the particular device; and
transmitting data to and receiving data from the particular device as a function of requirements of the selected one or more software applications and semantic information relating to the particular device.

10. The computer readable storage device of claim 9, comprising instructions for transmitting one or more of data and commands from the one or more software applications to one or more of the plurality of devices and from one or more of the plurality of devices to the one or more software applications.

11. The computer readable storage device of claim 9, comprising instructions for a user interface to receive the selection of the one or more software applications that are to be used in connection with the particular device.

12. The computer readable storage device of claim 11, wherein the user interface is configured to notify a user when an application is available for a device in the system.

13. The computer readable storage device of claim 9, comprising instructions for automatically informing a user when a new device is added to the system, and for receiving a selection of one or more of the software applications to be used in connection with the new device.

14. The computer readable storage device of claim 13, comprising instructions for transmitting data to and receiving data from the new device as a function of requirements of the selected one or more software applications for the new device and semantic information relating to the new device.

15. The computer readable storage device of claim 9, comprising instructions for receiving a request from a user for a list of software applications available for the particular device or a list of software applications available for the plurality of devices.

16. A process comprising:
storing in a computer storage device semantic information relating to each of a plurality of devices, the semantic information comprising a description of data that are associated with the plurality of devices;
storing a database of software applications that can be used in connection with the plurality of devices;
displaying to an output device one or more software applications that can be used in connection with a particular device;
receiving into a computer processor a selection of the one or more software applications that are to be used in connection with the particular device; and
transmitting data to and receiving data from the particular device as a function of requirements of the selected one or more software applications and semantic information relating to the particular device.

17. The process of claim 16, comprising automatically informing a user when a new device is added to the system, and receiving a selection of one or more of the software applications to be used in connection with the new device.

18. The process of claim 16, comprising transmitting data to and receiving data from the new device as a function of requirements of the selected one or more software applications for the new device and semantic information relating to the new device.

19. The process of claim 16, comprising receiving a request from a user for a list of software applications available for the particular device or a list of software applications available for the plurality of devices.

20. The process of claim 16, comprising capturing the semantic information via a device model.
